(19) United States
(12) Patent Application Publication
(10) Pub. No.: US 2026/0154230 A1
(43) Pub. Date: Jun. 4, 2026

(54) INTERCONNECTED MESH SYSTEMS AND METHODS OF USING SAME

(71) Applicant: Coraless Holdings, LLC, Dover, DE (US)

(72) Inventors: Giovanni C. Viscardi, Chesterfield, VA (US); Simon Lovell Bart, Brossard (CA)

(21) Appl. No.: 18/969,121

(22) Filed: Dec. 4, 2024

(51) Int. Cl. G06F 9/30; G06F 9/38; G06F 12/0875

(52) U.S. Cl. CPC G06F 15/17381; G06F 9/3016; G06F 9/3802; G06F 9/4881

(57) ABSTRACT

An exemplary embodiment of the present disclosure provides an interconnected mesh comprising an instruction cache, a plurality of cells, and a thread manager. The instruction cache can comprise instructions. The plurality of cells can comprise at least one cell. The at least one cell can comprise a functional unit, an execution queue, and a fetch queue. The thread manager can be configured to allocate the instructions form the instruction cache to the plurality of cells for execution.

### FIELD OF THE DISCLOSURE

The various embodiments of the present disclosure relate generally to interconnected mesh systems and methods of making and using same.

### BACKGROUND

There are major challenges in directing a series of instructions through microprocessors. The complexity arises from managing the timing requirements associated with processing these instructions, especially within the constraints of super-scalar microprocessors. Conventional methods, which were initially developed without a hardware-based solution, depended on maintaining a programmatic order of the series of instructions and responding to exceptions with a known state of the instructions in the system. Under these systems, functional units within the microprocessor can have their inputs connected together via an instruction issue system. However, these methods, which relied on a basic counting mechanism, proved inefficient.

Later, conventional systems began mapping reservation stations to functional units within a microprocessor and relying on a common data bus to broadcast output of the functional units along with results to a re-order buffer (to hold instructions until allowed to commit the instructions in order), reservation stations, and rename tables. The mapping of reservation stations included correlations to dedicated functional units configured to handle specific sub-set of instructions. In these systems, the inputs are connected together with a reservation station before executing in order to wait for a respective source argument for an instruction to be ready. This approach allowed for an out of order execution of the series of instructions. However, this solution still posed a challenge. Under this approach, instructions are still committed to the main registers or memory in the order in which the instructions were initially decoded in, which results in inefficiencies. Moreover, the synchronization of the system under this approach still necessitated frequent pauses and checks. The reasoning is to allow the running programs to maintain a stateful operation where they can stop at any given error or exception and know exactly the state of the processor at that time the error or exception was generated. Lastly, due to the use of dedicated functional units that are configured to handle specific sub-set of instructions, often times not all functional units would be operating while others were close to capacity. This results in a waste of resources. Accordingly, there is a need for an improved system for executing and processing instructions. Embodiments of the present disclosure address this need.

### BRIEF SUMMARY

The present disclosure relates to an interconnected mesh system for executing and processing instructions. An exemplary embodiment of the present disclosure provides an interconnected mesh. The interconnected mesh can comprise an instruction cache, a plurality of cells, and a thread manager. The instruction cache can comprise instructions. Each of the plurality of cells can comprise a functional unit, an execution queue, and a fetch queue. The thread manager can be configured to allocate the instructions from the instruction cache to the plurality of cells for execution.

In any of the embodiments disclosed herein, the instructions can comprise at least one instruction. The thread manager can be further configured to decode the at least one instruction and transmit the at least one instruction to a first cell in the plurality of cells for execution based on an availability of the first cell in the plurality of cells.

In any of the embodiments disclosed herein, the thread manager can be configured to transmit the at least one instruction to the first cell of the plurality of cells for execution based on availability of the first cell of the plurality of cells after determining a number of instructions in the execution queue of the first cell of the plurality of cells is below a predetermined threshold.

In any of the embodiments disclosed herein, the thread manager can be further configured to reallocate allocated instructions from the first cell of the plurality of cells to a second cell of the plurality of cells for execution when the number of instructions in the execution queue of the first cell of the plurality of cells is within a predetermined range of the predetermined threshold.

In any of the embodiments disclosed herein, each of the plurality of cells can be configured to execute allocated instructions concurrently without a master queuing system.

In any of the embodiments disclosed herein, each of the plurality of cells can be sub-processors configured to execute a task and the sub-processors can be non-specialized processors, specialized processors, or combinations thereof.

In any of the embodiments disclosed herein, the allocated instructions can be stored in the execution queue of the first cell. A portion of at least one of the allocated instructions can be stored in the fetch queue of the first cell, and the first cell can be configured to request data from another cell in the plurality of cells or from a memory based on at least one of allocated instructions.

In any of the embodiments disclosed herein, the thread manager can be further configured to assign a pair of tags comprising a global tag and a local tag to the at least one instruction. The global tag can be an ordinal position of the at least one instruction in the interconnected mesh and the local tag can be a dependency chain tag. The global tags of the instructions in the interconnected mesh can track the progress of the instructions as the instructions move through stages of execution. The ordinal position of the at least one instruction can represent a sequence number of the at least one instruction within the instructions being executed in the interconnected mesh.

In any of the embodiments disclosed herein, the thread manager can be further configured to receive a plurality of latest tags from at least a portion of allocated cells. The allocated cells can be active cells from the plurality of cells with allocated instructions from the thread manager. The plurality of latest tags can be corresponding global tags associated with latest executed instructions by the at least a portion of the allocated cells. The thread manager can be further configured to store an oldest tag among the plurality of latest tags as a programmatic state of the interconnected mesh for synchronization of the instructions in the interconnected mesh.

In any of the embodiments disclosed herein, the allocated cells can be further configured to execute allocated instructions using the functional unit and store the allocated instructions as executed instructions with a pending commit status.

In any of the embodiments disclosed herein, the allocated cells can be further configured to receive the programmatic state from the thread manager and determine whether the executed instructions comprise expired instructions by comparing global tags of the executed instructions with the pending commit status against the programmatic state. In any of the embodiments disclosed herein, the allocated cells can be further configured to, in response to determining the executed instructions comprise expired instructions with global tags older than the programmatic state, retire the expired instructions.

Another exemplary embodiment of the present disclosure provides a method for executing and processing instructions. The method can comprise decoding, with a thread manager, an instruction. The instruction can be previously retrieved from an instruction cache. The method can further comprise associating a unique identification with the instruction and transmitting the instruction to a computing resource for execution based on an availability of the computing resource. The unique identification can represent the computing resource assigned to execute the instruction.

In any of the embodiments disclosed herein, the method can further comprise executing, with the computing resource, the instruction and assigning a pending-commit status to the instruction. The method can further comprise storing the instruction at the computing resource.

In any of the embodiments disclosed herein, the instruction can be a first instruction and the method can further comprise receiving, at the thread manager, a subsequent instruction. The subsequent instruction can depend on the execution of the first instruction. The method can further comprise assigning, to the subsequent instruction, a second unique identification representing a corresponding computing resource assigned to execute the subsequent instruction and a dependency tag comprising the unique identification representing the computing resource assigned to execute the first instruction. Then the method can further comprise transmitting the subsequent instruction to the corresponding computing resource for execution.

In any of the embodiments disclosed herein, the subsequent instruction can be stored in an execution queue and at least a portion of the subsequent instruction can be stored in the fetch queue of the corresponding computing resource and the corresponding computing resource can be configured to request data from at least one other computing resource or from a memory when a stored instruction is dequeued from the fetch queue.

Another exemplary embodiment of the present disclosure provides a mesh system for executing and processing instructions. The mesh system can comprise a memory, a plurality of cells, and a thread manager. The memory can comprise an instruction stored thereon. Each of the plurality of cells can comprise a functional unit, an execution queue, and a fetch queue. The thread manager can be configured to allocate the instruction from the memory to the plurality of cells for execution by decoding the instruction retrieved from the memory, associating a unique identification to the instruction, and transmitting the instruction to the allocated cell for execution. The unique identification can represent an allocated cell of the plurality of cells assigned to execute the instruction.

In any of the embodiments disclosed herein, the thread manager can be further configured to assign a pair of tags comprising a global tag and a local tag to the instruction. The global tag can be an ordinal position of the instruction in the mesh system and the local tag can be a dependency chain tag. The global tags of instructions in the mesh system can track the progress of the instructions as the instructions move through stages of execution. The ordinal position of the instruction can represent a sequence number of the instruction within the instructions being executed in the mesh system.

In any of the embodiments disclosed herein, the allocated cell of the plurality of cells can be configured to execute the instruction using the functional unit, store the instruction with a pending commit status, and receive a programmatic state from the thread manager. The programmatic state can be an oldest tag among a plurality of latest tags received from the plurality of cells in the mesh system. The plurality of latest tags can be corresponding global tags associated with latest executed instructions by at least a portion of the plurality of cells. The allocated cell of the plurality of cells can also be configured to determine whether the instruction is expired by comparing the global tag of the instruction against the programmatic state, and in response to determining the global tag of the instruction is older than the programmatic state, retire the instruction.

In any of the embodiments disclosed herein, the instruction can be a first instruction and the thread manager can be further configured to receive a subsequent instruction. The subsequent instruction can depend on the execution of the first instruction. The thread manager can be further configured to assign, to the subsequent instruction, a second unique identification representing a corresponding allocated cell assigned to execute the subsequent instruction and a second dependency tag can comprise the unique identification representing the allocated cell assigned to execute the first instruction. The thread manager can be further configured to transmit the subsequent instruction to the corresponding allocated cell for execution.

In any of the embodiments disclosed herein, the subsequent instruction can be stored in execution queue and at least a portion of the subsequent instruction can be stored in the fetch queue of the corresponding allocated cell and the corresponding allocated cell can be configured to request data associated with the first instruction from the allocated cell or from memory when the subsequent instruction is dequeued from the fetch queue.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1A provides an illustration of processing system with reservation stations, functional units, a reorder buffer, and a common data bus, in accordance with an exemplary embodiment of a conventional disclosure.

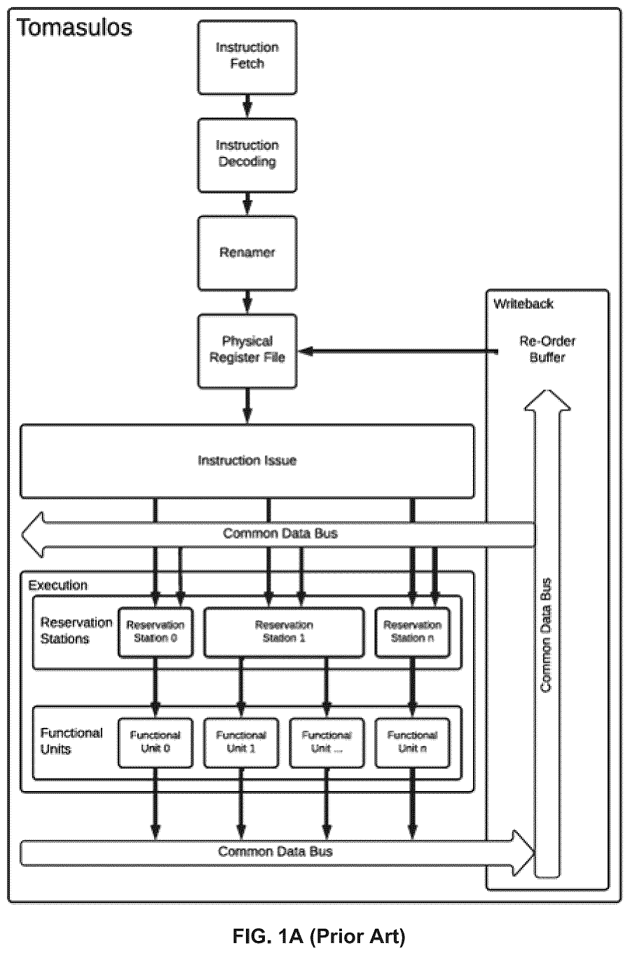

FIG. 1B provides an illustration of a processing system with reservation stations, specialized functional units, a reorder buffer, and a common data bus, in accordance with an exemplary embodiment of a conventional disclosure.

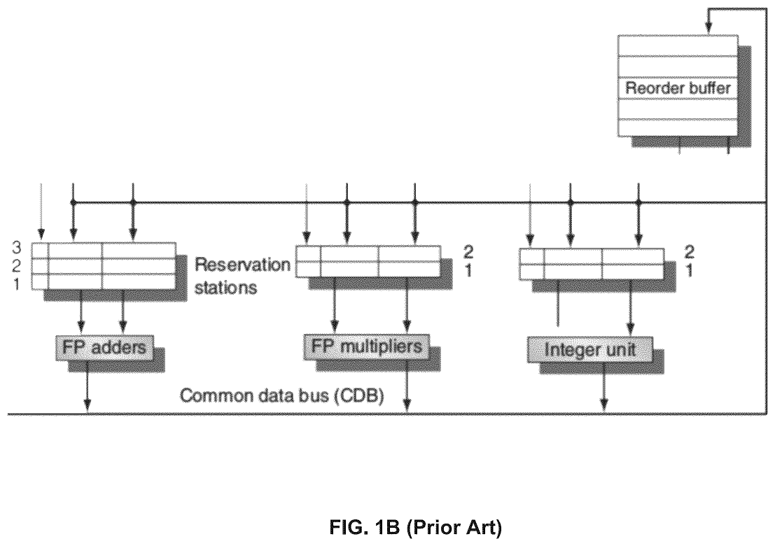

FIG. 1C provides an illustration of a processing system of an exemplary embodiment of a conventional disclosure.

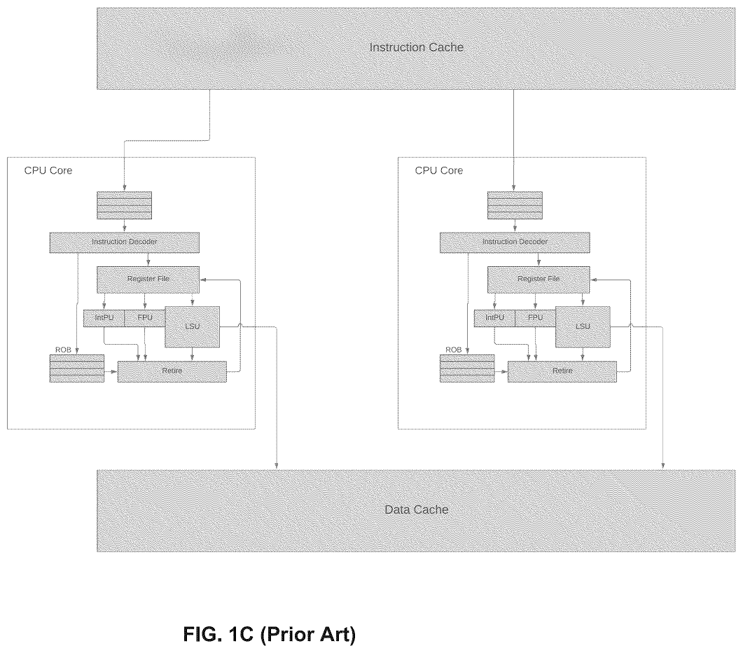

FIG. 2 provides an illustration of an interconnected mesh system, in accordance with an exemplary embodiment of the present disclosure.

FIG. 3 provides an illustration of a process for synchronizing an interconnected mesh system, in accordance with an exemplary embodiment of the present disclosure.

FIG. 4 provides an illustration of a cell with a functional unit and queues, in accordance with an exemplary embodiment of the present disclosure.

FIG. 5 provides an illustration of an interconnected mesh system, in accordance with an exemplary embodiment of the present disclosure

FIG. 6 provides a flow diagram outlining the method of directing an instruction for execution, in accordance with an exemplary embodiment of the present disclosure.

FIG. 7 provides a flow diagram outlining the method of directing a subsequent instruction for execution, in accordance with an exemplary embodiment of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As discussed above, conventional systems with processors that execute instructions rely on master queuing systems to coordinate the execution of instructions due to complex dependencies between the instructions. Embodiments of the present disclosure, however, are not so limited. Rather, embodiments of the present disclosure can execute instructions out of order without a queuing system or common data bus. The present disclosure uses an interconnected mesh 100 comprising clusters of cells 115 managed by thread managers 110 to efficiently execute instructions. The cells of the plurality of cells 115 do not have to be all specialized or dedicated microprocessors and can flexibly configured to execute instructions. The cells 115 can operate simultaneously with minimal impact and can efficiently distribute instructions to have more functional units operating. The present disclosure also solves the synchronization issue involved with such out of order, flexible systems. It is with respect to these and other considerations that the various embodiments described below are presented.

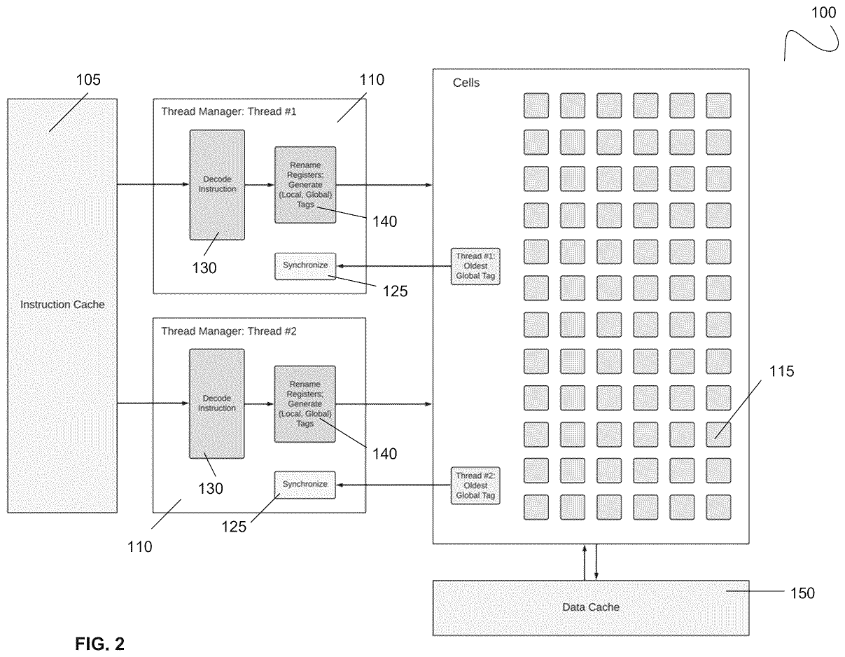

As shown in FIGS. 2-5, an exemplary embodiment of the present disclosure provides an interconnected mesh 100 comprising an instruction cache 105 (e.g., a memory), a plurality of cells 115, thread managers 110, and/or data caches 150. The interconnected mesh 100 comprising cells 115 can execute instructions in parallel. The cells 115 can be grouped in clusters that are each managed by a thread manager 110. The interconnected mesh 100 can have a plurality of thread managers 110. Each thread manager 110 in the interconnected mesh 100 can manage a plurality of cells 115. Any of the thread managers 110 can flexibly manage the clusters of cells 115 grouped in a shared compute pool.

Although an exemplary interconnected mesh 100 is described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in this interconnected mesh 100, such as the interconnected mesh 100, for example, may be configured to operate as virtual instances on the same physical machine. In other words, by way of example one or more of the interconnected mesh 100 may operate on the same physical device rather than as separate devices communicating through communication network(s). Additionally, there may be more or fewer interconnected mesh 100 than illustrated in the figures.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to conduct steps necessary to implement the methods of the examples of this technology that are described and illustrated herein.

In a non-limiting example, a first thread manager 110 can manage a first group of plurality of cells 115. A second thread manager 110 can manage a second group of plurality of cells 115. The second thread manager 110, as permitted by the present disclosure, can overtake the management of the cell 115 and incorporate the cell 115 into the second group of plurality of cells 115. To enhance the efficiency of the interconnected mesh 100, a different thread manager 110 (e.g., the second thread manager 110) may take over the management of the cell 115 managed by the original thread manager 110 (e.g., the first thread manager 110) (e.g., the second thread manager 110 can reallocate instructions from one of the cells in the second group of plurality of cells 115 to the cell 115). Alternatively, or additionally, when the number of instructions in an execution queue of a cell falls within a predetermined range of a set threshold, the original thread manager 110 can be configured to reallocate instructions from the cell to a different cell within the first group of plurality of cells 115.

Additionally, the interconnected mesh 100 can have the architecture illustrated in FIG. 2. As illustrated, the instruction cache 105 can be connected to the thread managers 110. The thread managers 110 can have corresponding data caches 150 as illustrated. The thread managers, connected to the corresponding data caches 150 and/or the plurality of cells 115, can be configured to send and receive data (e.g., instructions) to the data caches 150 and/or the plurality of cells 115. The subsequent sections provide illustrations of functionalities and processes that the components of the interconnected mesh 100 can be configured to perform.

### INSTRUCTION CACHE

The instruction cache 105 can be the main memory of the system 100 or can be cache memory. The instruction cache 105 can be memory used to hold data or instructions. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory (or instruction cache 105).

In a non-limiting example, the instruction cache 105 can comprise instructions. The instructions can comprise at least one instruction. A thread manager 110 can retrieve instructions from the instruction cache 105 for execution. The instruction cache 105 can store one or more applications that can include the instructions that can cause the interconnected mesh 100 to perform actions as described and illustrated in the examples below. The application(s) can be implemented as modules, programmed instructions, or components of other applications. Further, the application(s) can be implemented as operating system extensions, module, plugins, or the like. Even further, the application(s) may be operative in a cloud-based computing environment. The application(s) can be executed within or as virtual machine(s) or virtual server(s) that may be managed in a cloud-based computing environment. Also, the application(s), and even the interconnected mesh 100 itself, may be located in virtual server(s) running in a cloud-based computing environment rather than being tied to one or more specific physical computing devices. Also, the application(s) may be running in one or more virtual machines (VMs) executing on the mesh system 100. Additionally, in one or more embodiments of this technology, virtual machine(s) running on the mesh system 100 may be managed or supervised by a hypervisor.

### PLURALITY OF CELLS

### A. Functions of a Cell

In the interconnected mesh 100, a cell 115 can be used to perform an operation based on an instruction. A cell 115 can be a module or a computing resource of a computer system. A computing resource refers to any physical or virtual component that contributes to a system's ability to perform an operation. Non-limiting examples of computing resources can include hardware components (e.g., storage devices, input/output devices) or software components (e.g., applications or drivers).

The cell 115 can be a non-dedicated microprocessor (or a non-specialized processor) that is not required to execute a specific sub-set of instructions. The cell 115 can also be a specialized processor with specific hardware to execute specific types or sub-set of instructions. In a non-limiting example, when the cell 115 is a non-specialized processor, the cell 115 can perform fast and basic arithmetic logic, graphics processing units, floating point units, network processing units, cryptographic processing tasks, input/output (I/O) processing tasks, real-time processing tasks, and other tasks known in the art. The cell 115 does not have to be dedicated to performing only one of the available tasks (such as only performing I/O processing tasks). In another non-limiting example, when the cell 115 is a specialized processor configured to perform a certain type of task such as only I/O processing tasks, the cell 115 may include specific hardware for processing such tasks, and instructions requiring I/O processing tasks may be sent to the cell 115 for execution.

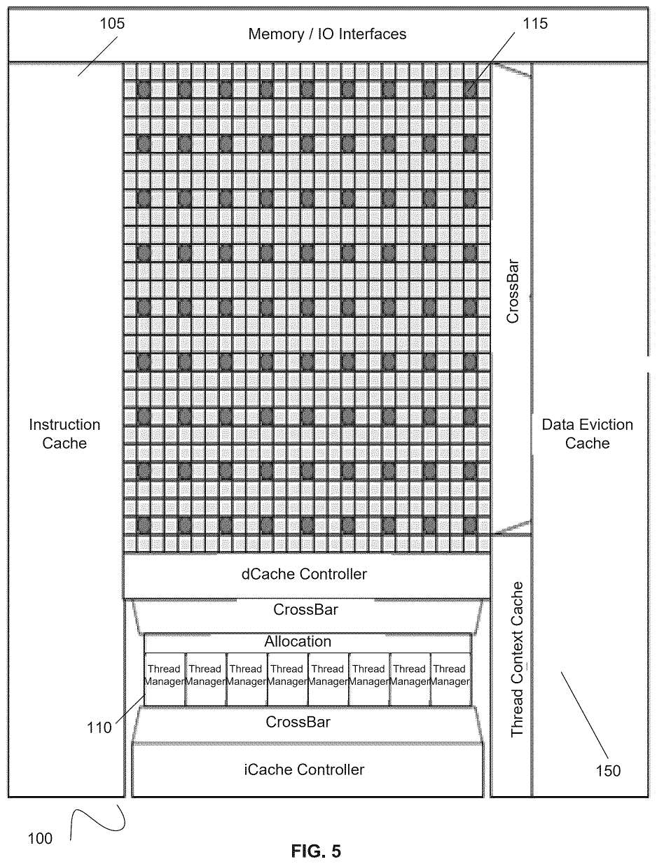

In a non-limiting example as depicted in FIG. 5, cells 115 can be arranged in groups where a middle of each group of cells 115 is specialized. (In FIG. 5, the middle of each of the group of cells 115 is represented as a circle.) In one example, the middle of each group of cells 115 can be a localized data cache and can be configured to execute specific instructions. In another example, the middle of each group of cells 115 can be configured to process instructions related to 64-bit floating point operations, while the remaining cells 115 in the group of cells 115 are configured to process 32-bit operations. As depicted in FIG. 5, the interconnected mesh 100 can comprise of cells 115 that are non-specialized processors, specialized processors, or a combination thereof.

The cell 115 can be a processor capable of executing programmed instructions stored in the memory (or instruction cache 105) of the interconnected mesh 100 for any number of functions and other operations as illustrated and described by way of the examples herein. The cell 115 may include one or more CPUs or general purpose processors with one or more processing cores, for example, although other types of processor(s) can also be used.

### B. Architecture of a Cell

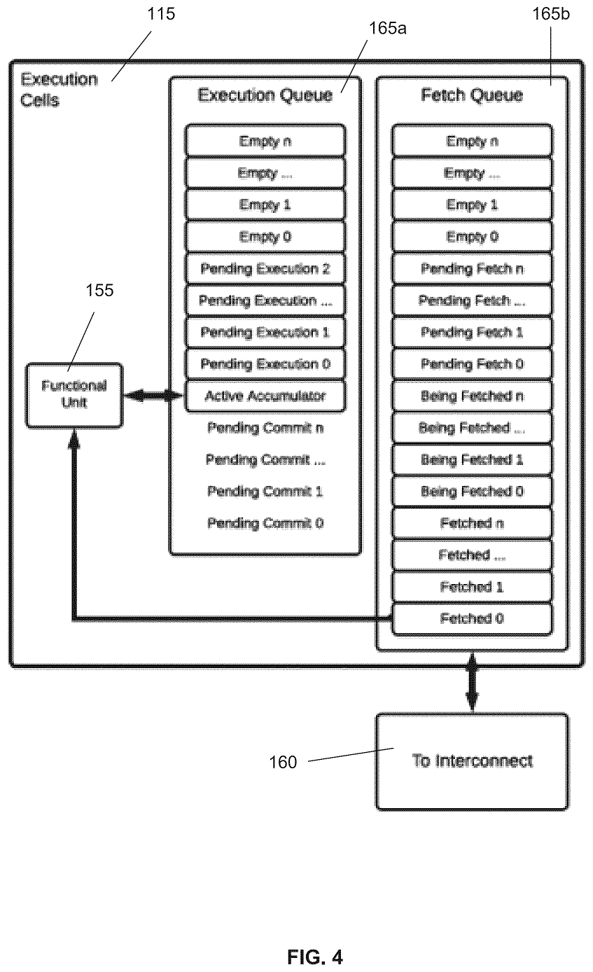

In this non-limiting example, as illustrated in FIG. 4, each of the plurality of cells 115 can comprise a functional unit 155 and a queue 165. The functional unit 155 can be a sub-processor capable of carrying out specific processing activities on behalf of a data controller. The queue 165 can be several queues 165 that aid in execution of instructions, such as an execution queue 165a and a fetch queue 165b as illustrated in FIG. 4. Additionally, the interconnected mesh 100 can comprise a plurality of a plurality of cells 115 each managed by a thread manager 110. As a result, the interconnected mesh 100 can have more functional units to operate simultaneously with minimal impact, which is an advantage over conventional methods.

Furthermore, the plurality of cells can be configured to execute allocated instructions concurrently without a master queuing system. As outlined above, with a master queuing system, processors commit instructions based on a specific order of instructions or priority. In a system with a master queuing system, tasks or instructions are queued in a reservation station in order. The processor then dequeues the instructions out-of-order. The results are then queued in a re-order buffer, and later dequeued in order. This process continues until the queue is empty. The order of execution can be determined by various algorithms, such as First-In-First-Out (FIFO), Last-In-First-Out (LIFO), or a priority-based system. In a multi-processor environment, multiple queues may exist, with each processor having its own queue, or a single shared queue may be used. The queuing system helps manage workload efficiently, ensuring that all tasks are executed in an orderly and controlled manner. In contrast, with an interconnected mesh 100, the plurality of cells can be configured to execute allocated instructions concurrently without a master queuing system. The interconnected mesh 100 eliminates the re-order buffer to keep the program synchronized and can have the plurality of cells work simultaneously on the execution of the instructions regardless of the order.

### C. Registers Mapped to a Cell

Under this non-limiting disclosure, architectural registers, capable of temporarily storing data for the execution of the instructions, can be mapped to the plurality of cells 115. The registers can be further configured to store arguments associated with an instruction. The mapping of architectural registers to the plurality of cells 115 can be any ratio greater than 1:1, which can result in a higher potential performance gain.

### D. Processing an Instruction with a Cell

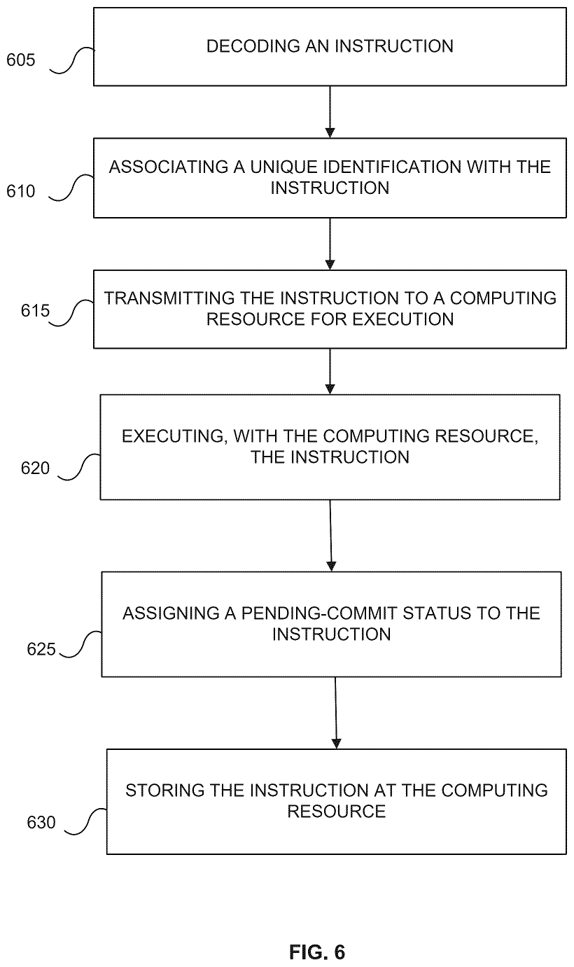

In the operational flow, in step 615 of FIG. 6, a cell 115 receives an instruction from a thread manager 110, which is then stored in an execution queue 165a. If the instruction is dependent on the results of another instruction or from memory, meaning it requires the outcome of a different instruction or an item from memory before it can proceed, all or some part of the instruction is additionally stored in a fetch queue 165b. The portion of the instruction stored in the fetch queue 165b can include portions of the instruction that are relevant to fetching the required data from a different cell or from memory. In step 620 of FIG. 6, when ready for processing, the cell 115 dequeues the instruction from the execution queue 165a and processes it using a functional unit 155. Under step 625 of FIG. 6, upon completion of the instruction execution, the executed instruction is marked with a pending-commit status, indicating that it has been executed. Then under step 630, the cell 115 stores the instruction, along with any resulting data, back in the execution queue 165a.

a. Ping Pong Method/Retiring Instructions

Conventionally, before retiring an instruction, a computing system first ascertains that the instruction will not be used in future computations. If this is not ensured, the system could potentially transition into a retired state, leading to erroneous results or system instability. Conventional methods manage this process by retiring instructions in a programmatic order or using a basic counting mechanism. This approach ensures that instructions are processed in a specific sequence, reducing the risk of prematurely retiring an instruction that might be needed later. However, this method requires careful management and tracking of instruction dependencies to maintain system integrity.

In the interconnected mesh 100, a cell 115 does not know exactly where all other registers are mapped at any given time. There is no central buffer structure that takes all results produced by the system and reorders them according to a programmatic order. To synchronize the interconnected mesh 100 and to avoid retiring an instruction that might be used later, the interconnected mesh 100 can use a ping pong method.

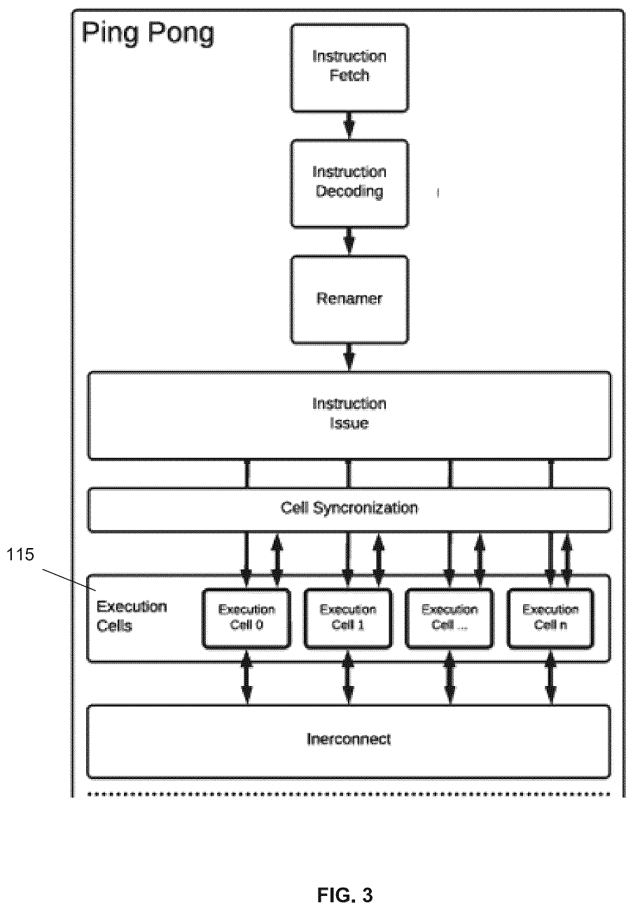

In this non-limiting example, as illustrated in FIG. 3, the ping pong method can include three phases: (i) a ping or issue phase, (ii) a pong phase, and (iii) an update phase. Under the ping or issue phase, a thread manager 110 can be configured to assign a pair of tags comprising a global tag and a local tag to an instruction. The thread manager 110 can assign the pair of tags prior to transmitting the instruction to one of the cells in the plurality of cells 115. The global tag can be an ordinal position of the at instruction in the interconnected mesh 100 (or a thread-global programmatically ordered tag) and the local tag can be a dependency chain tag (or a local tag). The global tag can help track the progress of each instruction in the interconnected mesh 100 as the instructions move through the various stages of execution. The dependency chain tag can help identify dependencies between instructions to assist executing instructions in a correct order.

During the pong phase, a cell 115 with allocated instructions (an allocated cell) can periodically be configured to send a message with a furthest programmatic progress to a thread manager 110 by transmitting a latest tag (i.e., a global tag of the last instruction executed by the cell 115). The thread manager 110 can manage and receive a plurality of latest tags from cells 115 with allocated instructions (or allocated cells). The allocated cells 115 can be active cells from the plurality of cells 115 with allocated instructions from the thread manager 110. The plurality of latest tags can be corresponding global tags associated with latest executed instructions by each of the allocated cells. The latest executed instruction of a cell 115 can be the last instruction that the cell 115 executed. The latest executed instruction can be an executed instruction with a pending-commit status stored in the execution queue 165a of the cell 115. For system synchronization, the thread manager 110 can be configured to store an oldest tag among the plurality of latest tags as a programmatic state of the interconnected mesh 100. The thread manager 110 can determine which of the plurality of latest tags is the oldest tag by comparing the plurality of latest tags. The oldest tag represents the furthest common state in programmatic order that all active cells 115 have reached. The common programmatic state represents a point in the interconnected mesh 100 where any result (global tag of an instruction) that is older than the programmatic state will inherently not be used by another in-flight instruction unless it is the only valid copy of that architectural register.

Under the update phase, a thread manager 110 can transmit a message to a cell 115 with the programmatic state of the interconnected mesh 100 to retire instructions with pending-commit status with global tags older than the programmatic state. The cell 115 can be further configured to retire expired instructions by determining whether the instructions comprise expired instructions by comparing global tags of the executed instructions with the pending commit status against the programmatic state.

b. Interconnect Requests

The shared pool of the plurality of cells 115 can be linked via an interconnect 160. The interconnect 160 can be configured to allow any of the shared pool of the plurality of cells 115 to fetch data from other cells within in the shared pool or from a memory. A thread manager 110 can allocate an instruction to a cell 115 that has a dependency chain tag (i.e., the instruction has dependencies on results from other instructions). The cell 115 can store the instruction or a portion of the instruction with the dependencies in the fetch queue 165b. When the cell 115 dequeues the instruction with the dependencies from the fetch queue 165b, the cell 115 can request data from an execution queue 165a of another cell 115 that generated the data needed for the instruction or from memory. The cell 115 can request the data using the interconnect 160. The dependency chain tag can have a location of the another cell 115, allowing the cell 115 to directly request data from the another cell 115 without using a common data bus or consulting the thread manager 110.

### THREAD MANAGERS

### A. Architecture of a Thread Manager

An interconnected mesh 100 can have a configuration with varying amounts of thread managers 110 connected to a plurality of plurality of cells 115. The number of thread managers 110 can be tuned for a given interconnected mesh 100 configuration to provide target performance metrics. As illustrated in FIG. 2, each thread manager 110 can comprise a queue 120, an instruction decoder 130, a register renamer 140, and a synchronizer 125.

The instruction decoder 130 can be configured to decode instructions. An instruction decoder 130 can translate machine language instructions into a format that can be understood and executed by a processor or microprocessor (such as a cell 115). The instruction decoder 130 takes the binary code for an instruction as input and decodes it into a set of control signals that drive the other parts of the processors. This decoding process enables a processor to perform a specific operation dictated by each instruction, such as arithmetic operations, data movement, or control flow changes.

A register renamer 140 avoids exceptions and errors by assigning unique identifiers (or associating a unique identification with instructions) to instances of registers used in the interconnected mesh 100. Each instruction operates using data in registers for its arguments. The register renamer 140 points a source argument of an instruction to their required values. Instructions can be given names that have multiple fields, which can hold information about the overall thread progression. In particular, instructions can have N arguments. In an example of renaming instructions using conventional methods, an instruction can have three (3) arguments which may include a source A, a source B, and a destination. A conventional processor may perform an operation such as addition using source A and source B, and then store a result of the operation at the destination.

In contract, in a non-limiting example for the present disclosure, the interconnected mesh 100 can use instructions in a two (2) argument format. The register renamer 140 can convert instructions with N arguments into a two (2) argument format when appropriate. The first argument can represent a cell 115 location where an operation for an instruction is to be performed (i.e., an execution queue 165a) and the second argument can represent a memory location where data may be fetched for the instruction (i.e., a fetch queue 165b). Under a two (2) argument format, the register renamer 140 can store new names for destinations after names for sources are referenced. If an instruction has a destination argument that does not match one of its source arguments, the instruction will not be able to be simplified into a two argument instruction. The present disclosure solves this issue by splitting the instruction using a move operation to simulate a two (2) argument operation.

In such examples, the register renamer 140 can first determine whether the instruction is already in a two (2) argument format by verifying whether the destination argument matches one or more of the source arguments. If the instruction has a source argument that does not match the destination argument, the register renamer 140 can split the instruction into two (2) separate sub-instructions by injecting a move operation to simulate a two (2) argument operation. This added instruction is a move, which allows for the emulation of a three (3) argument instructions by replacing the destination argument with a value from one of the sources. In other words, using the instruction with three (3) arguments that include a source A, a source B, and a destination C as an example, the register renamer 140 can: move source A to destination C (i.e., a move operation), add source A and destination C, and then store a result of the addition at the destination C (as outlined in Example 3 below and not repeated herein for brevity). This move operation can be repeated as necessary for instructions with N arguments. Because the source is taken to the destination where the addition operation will be performed and corresponding result saved, the present disclosure is able to allow the thread managers 110 to allocate instructions to a new cell 115 (as described in section B, ‘processing an instruction with a thread manager’ below, and not repeated herein for brevity) or new cells 115 to a thread manager 110 if appropriate without dependency issues. This lack of dependency allows for independent processing because the interconnected mesh 100 is able to allocate cells 115 to a thread manager 110 that are not continuation cells of another cell. New dependency chains in the new allocated cells 115 due to the two (2) argument format permit a fresh start for each of the new allocated cells 115.

Turning to the synchronizer 125, as outlined above under the ping pong method, the thread manager 110 collaborates with cells 115 that have allocated instructions to retire expired instructions using a determined programmatic state of the interconnected mesh 100. This method involves a series of steps to synchronize the interconnected mesh 100. To carry out these steps, the thread manager 110 can utilize the synchronizer 125.

### B. Processing an Instruction with a Thread Manager

As illustrated in FIG. 6, a thread manager 110 can be configured to retrieve instructions from the instruction cache 105 to a queue 120 in the thread manager 110. Then as illustrated in step 605 of FIG. 6, the thread manager 110 can send the instructions to the instruction decoder 130, where the instruction decoder 130 can be configured to decode the instructions. The thread manager 110 can then use the register renamer 140 to point source arguments of the instructions to their respective values in registers.

Under step 610 of FIG. 6, the thread manager 110 can associate a unique identification with the instruction by assigning the instructions to cells 115 for execution. When one of the instructions have an active dependency chain, the thread manager 110 can select a target cell 115 for execution of the instruction based on a location of a dependent instruction in the active dependency chain. The thread manager 110 can then determine whether the target cell 115 comprises a number of instructions in an execution queue 165a below a predetermined threshold. If the number of instructions is below the predetermined threshold, the thread manager 110 can assign the instruction to the target cell 115. Otherwise, if the number of instructions is above the predetermined threshold, the thread manager 110 can allocate the instruction to a new cell 115 with the active dependency chain of the target cell 115. The thread manager 110 can inject a move instruction into the code stream to retrieve a latest result from the target cell 115 because it is almost full or at maximum capacity, to use the latest result as a base context for the new instruction being allocated to the new cell 115.

When the instruction being allocated does not have an active dependency chain, the thread manager 110 can evaluate the cells 115 to determine a target cell 115 for the instruction. The thread manager 110 can assign the instruction to a cell 115 for execution based on an availability of the cells 115 by determining whether a potential cell 115 comprises a number of instructions in an execution queue 165a below a predetermined threshold. When a target cell 115 is not available (i.e., the number of instructions in the execution queue 165a is within a predetermined range of the predetermined threshold or is above the predetermined threshold), then the thread manager 110 can select a different cell as the target cell 115 until a target cell 115 that is available is selected. When a target cell 115 is selected because it is available (i.e., the number of instructions in the execution queue 165a is below the predetermined threshold), then the thread manager 110 can select the target cell 115 for the assignment of the instruction.

After selecting the cells 115, the thread manager 110 assigns the instructions to the cells 115 by associating unique identifications representing corresponding cells 115 to each instruction. The thread manager 110 then issues a pair of tags as described above (and not repeated herein for brevity) including a global tag and a dependency tag comprising the unique identification representing the corresponding cell 115 for the instruction. Then under step 615 of FIG. 6, the thread manager 110 transmits the instructions to their respective assigned cells 115 for execution. Each of the assigned cells 115 can then execute steps 620 through 630 (as described above and not repeated herein for brevity).

During the processing of instructions, the thread manager can be further configured to reallocate allocated instructions from a plurality of cells 115 to another one of the plurality of cells 115 for execution when a number of instructions in an execution queue 165a of a cell 115 is within a predetermined range of a predetermined threshold of a capacity of the cell 115. As a capacity of a cell 115 fills up, the respective thread manager 110 can request another cell from the shared pool of cells 115 to handle instructions from the cell 115. The thread manager 110 can inject a move instruction into the code stream to retrieve a latest result from the cell 115 to use as a base context for the fresh group of cells 115 or an individual cell 115 being allocated the reallocated instructions. A fresh group of cells 115 or an individual cell 115 is always standing by and available to seamlessly process new tasks. Due to the non-specialized functioning units of the cells 115, the fresh group of cells 115 or the individual cell 115 can process the new tasks regardless of the type of task.

### C. Processing Subsequent Instructions with a Thread Manager

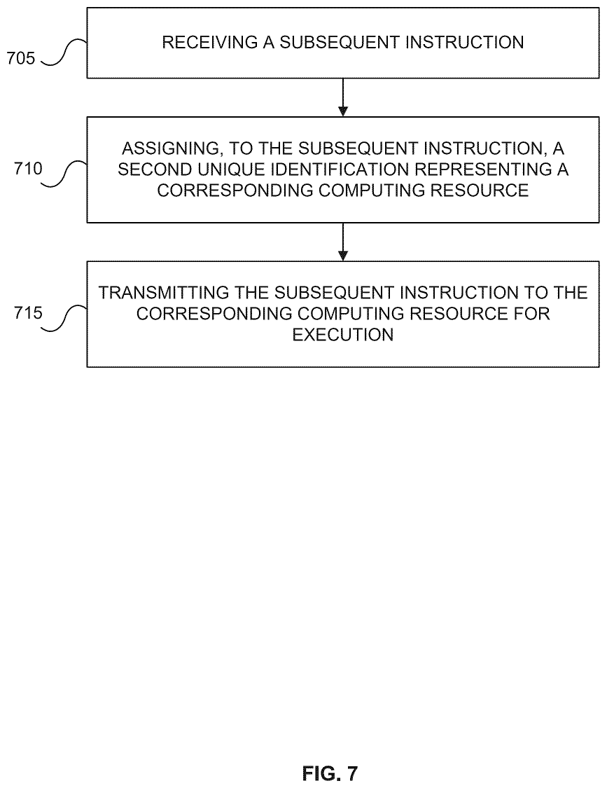

As illustrated in FIG. 7, under step 705, an instruction can be a first instruction and a method can comprise receiving, at the thread manager, a subsequent instruction. The thread manager 110 can retrieve the subsequent instruction from the instruction cache 105 and can decode the subsequent instruction using the instruction decoder 130. The subsequent instruction can depend on the execution of the first instruction.

Under step 710 in FIG. 7, the method can further comprise assigning, to the subsequent instruction, a second unique identification representing a corresponding cell 115 assigned to execute the subsequent instruction along with a dependency tag comprising a unique identification representing a cell 115 assigned to execute the first instruction. The corresponding cell 115 can be assigned using the methods described above (based on the availability of the corresponding cell 115). The dependency tag can comprise the unique identification representing the cell 115 that is executing the first instruction so that the corresponding cell 115 can have a location of where to later request the result computed from the execution of the first instruction.

Under step 715 in FIG. 7, the method can further comprise transmitting the subsequent instruction to the corresponding cell 115 for execution. The subsequent instruction can be stored in the fetch queue of the corresponding cell 115 and the corresponding cell 115 can be configured to request data from the cell 115 executing the first instruction by using the unique identification using the cell 115 executing the first instruction, when the subsequent instruction is dequeued from the fetch queue.

The following examples further illustrate aspects of the present disclosure. However, they are in no way a limitation of the teachings or disclosure of the present disclosure as set forth herein.

### EXAMPLES

The interconnected mesh 100 and methods can be used for efficiently routing instructions to computing resources for execution, including, but not limited to, using thread managers 110 to assign instructions to cells 115 for execution.

In a second example, the disclosed methods herein can be used for synchronization of an interconnected mesh 100 without a use of a common data bus or master queueing system, including, but not limited to, by using a ping pong method with a pair of tags and a global programmatic state of the interconnected mesh 100. A non-limiting example of the ping pong method can include a specific thread manager 110 managing four cells with allocated instructions. Prior to an update or pong phase, the cells can be allocated with the following instructions: Cell 0 contains ‘a’, ‘c’, ‘i’, ‘l’, ‘n’, ‘q’, and ‘s’. Cell 1 contains ‘b’, ‘e’, ‘f’, ‘j’, and ‘o’. Cell 2 contains ‘d’, ‘g’, and ‘m’, while Cell 3 contains with ‘h’, ‘k’, ‘p’, and ‘r’. Under a pong phase, the global tags of the latest instructions from each cell sent to the thread manager 115 for the determination of a programmatic state can be as follows: ‘n’ for Cell 0, ‘o’ for Cell 1, ‘m’ for Cell 2, and ‘p’ for Cell 3. At this point, the thread manager 110 can determine the programmatic state to be ‘m’. Under an update phase, the thread manager 110 can send the programmatic state to the cells to retire instructions with a pending-commit status. The cells can retire instructions as follows under this non-limiting example: Cell 0 can retire the instructions ‘a’, ‘c’, ‘i’, and ‘l’. For Cell 1, the instructions ‘b’, ‘e’, ‘f’, and ‘j’ can be retired. For Cell 2, the instructions ‘d’ and ‘g’ can be retired, and for Cell 3, the instructions ‘h’ and ‘k’ can be retired. After this update phase, the pending-commit instructions left in each cell can be as follows: Cell 0 can contain ‘n’, ‘q’, and ‘s’. Cell 1 can contain ‘o’. Cell 2 can contain ‘m’, and Cell 3 can contain ‘p’and ‘r’.

In a third example, the invention can include a register renaming method. In a non-limiting example, an instruction can reference the following source and destination arguments: r4=r6+r2. In this example, the source argument does not match the destination argument. The source argument r4 is not equal to r6 and r4 is not equal to r2. As a result, the instruction can be divided into two separate sub-instructions: r4=r6 (first sub-instruction) and r4=r4+r2 (second sub-instruction). The first sub-instruction involves r4 and r6. Here, r4 is creating a new value, and the instruction does not depend on any prior values stored to r4. Therefore, the system can copy r6 into r4 and optionally start a new dependency chain by issuing this instruction to a freshly allocated cell 115. This initiates a new dependency chain tag series, and all subsequent operations that require this result can follow this dependency chain. In this example, r4 is assigned a new name, #62. The source argument r6 may or may not have pending dependencies.

To emulate a three-argument instruction on a two-argument system, the system can inject a move operation into the instruction stream by taking an existing tag and use it to form the move operation. In this example, r6 retains its existing name of #47.

The second sub-instruction involves r4 and r2. This is the two-argument instruction that performs the operation requested by the program. The destination and the source are the same, so the system assigns the source argument the existing name stored for r4 (which was generated just above) and the system generates a new name for the destination argument. In this example, the r4 destination can be assigned a new name of #66, and the r4 source can retain #62. The argument r2 is treated like a normal source argument and is given the existing name in the renamer, in this case, #58. The resulting instructions would then look like: Sub-Instruction 1: #62=#47 and Sub-Instruction 2: #66=#62+#58.

In another non-limiting example, a different example instruction can be r7=r7+r3. The destination and one of the sources can be the same, so a split is not required. Since no split is required, this instruction is treated exactly the same as Sub-Instruction 2 in the split case above (not repeated herein for brevity). The destination and source register r7 is issued a new name and existing name, respectively. In this example, the destination r7 is given a new name of #27, and the source r7 retains the existing name of #21. The argument r3 is also treated like the source argument of Sub-Instruction 2 in the split case. It is just a source argument, so it is issued an existing name. In this example, r3 is given the existing name #18. The resulting instruction would then look like: #27=#21+#18.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. An interconnected mesh comprising:
an instruction cache comprising instructions;
a plurality of cells, each of the cells comprising a functional unit, an execution queue, and a fetch queue; and
a thread manager configured to allocate the instructions from the instruction cache to the plurality of cells for execution.

2. The interconnected mesh of claim 1, wherein the instructions comprise at least one instruction and wherein the thread manager is further configured to:
decode the at least one instruction; and
transmit the at least one instruction to a first cell in the plurality of cells for execution based on an availability of the first cell in the plurality of cells.

3. The interconnected mesh of claim 2, wherein the thread manager is configured to transmit the at least one instruction to the first cell of the plurality of cells for execution based on availability of the first cell of the plurality of cells after determining a number of instructions in the execution queue of the first cell of the plurality of cells is below a predetermined threshold.

4. The interconnected mesh of claim 3, wherein the thread manager is further configured to reallocate allocated instructions from the first cell of the plurality of cells to a second cell of the plurality of cells for execution when the number of instructions in the execution queue of the first cell of the plurality of cells is within a predetermined range of the predetermined threshold.

5. The interconnected mesh of claim 2, wherein each of the plurality of cells are configured to execute allocated instructions concurrently without a master queuing system.

6. The interconnected mesh of claim 2, wherein each of the plurality of cells are sub-processors configured to execute a task and wherein the sub-processors comprise non-specialized processors, specialized processors, or combinations thereof.

7. The interconnected mesh of claim 2, wherein the allocated instructions are stored in the execution queue of the first cell, wherein a portion of at least one of the allocated instructions is stored in the fetch queue of the first cell, and wherein the first cell is configured to request data from another cell in the plurality of cells or from a memory based on the at least one of allocated instructions.

8. The interconnected mesh of claim 2, wherein the thread manager is further configured to:
assign a pair of tags comprising a global tag and a local tag to the at least one instruction,
wherein the global tag is an ordinal position of the at least one instruction in the interconnected mesh and the local tag is a dependency chain tag,
wherein global tags of the instructions in the interconnected mesh track the progress of the instructions as the instructions move through stages of execution, and
wherein the ordinal position of the at least one instruction represents a sequence number of the at least one instruction within the instructions being executed in the interconnected mesh.

9. The interconnected mesh of claim 8, wherein the thread manager is further configured to:
receive a plurality of latest tags from at least a portion of allocated cells, wherein the allocated cells are active cells from the plurality of cells with allocated instructions from the thread manager, wherein the plurality of latest tags are corresponding global tags associated with latest executed instructions by the at least a portion of the allocated cells; and
store an oldest tag among the plurality of latest tags as a programmatic state of the interconnected mesh for synchronization of the instructions in the interconnected mesh.

10. The interconnected mesh of claim 9, wherein the allocated cells are further configured to:
execute allocated instructions using the functional unit; and
store the allocated instructions as executed instructions with a pending commit status.

11. The interconnected mesh of claim 10, wherein the allocated cells are further configured to:
receive the programmatic state from the thread manager;
determine whether the executed instructions comprise expired instructions by comparing global tags of the executed instructions with the pending commit status against the programmatic state; and
in response to determining the executed instructions comprise expired instructions with global tags older than the programmatic state, retire the expired instructions.

12. A method comprising:
decoding, with a thread manager, an instruction, wherein the instruction was retrieved from an instruction cache;
associating a unique identification with the instruction, wherein the unique identification represents a computing resource assigned to execute the instruction; and
transmitting the instruction to the computing resource for execution based on an availability of the computing resource.

13. The method of claim 12, further comprising:
executing, with the computing resource, the instruction;
assigning a pending-commit status to the instruction; and
storing the instruction at the computing resource.

14. The method of claim 12, wherein the instruction is a first instruction and wherein the method further comprises:
receiving, at the thread manager, a subsequent instruction, wherein the subsequent instruction depends on the execution of the first instruction;
assigning, to the subsequent instruction, a second unique identification representing a corresponding computing resource assigned to execute the subsequent instruction and a dependency tag comprising the unique identification representing the computing resource assigned to execute the first instruction; and
transmitting the subsequent instruction to the corresponding computing resource for execution.

15. The method of claim 14, wherein the subsequent instruction is stored in an execution queue and at least a portion of the subsequent instruction is stored in a fetch queue of the corresponding computing resource and wherein the corresponding computing resource is configured to request data from at least one other computing resource or from a memory when a stored instruction is dequeued from the fetch queue.

16. A mesh system comprising:
a memory comprising an instruction stored thereon;
a plurality of cells, each of the cells comprising a functional unit, an execution queue, and a fetch queue;
a thread manager configured to allocate the instruction from the memory to the plurality of cells for execution by:
decoding the instruction retrieved from the memory;
associating a unique identification to the instruction, wherein the unique identification represents an allocated cell of the plurality of cells assigned to execute the instruction; and
transmitting the instruction to the allocated cell for execution.

17. The mesh system of claim 16, wherein the thread manager is further configured to:
assign a pair of tags comprising a global tag and a local tag to the instruction,
wherein the global tag is an ordinal position of the instruction in the mesh system and the local tag is a dependency chain tag,
wherein global tags of instructions in the mesh system track the progress of the instructions as the instructions move through stages of execution, and
wherein the ordinal position of the instruction represents a sequence number of the instruction within the instructions being executed in the mesh system.

18. The mesh system of claim 17, wherein the allocated cell of the plurality of cells is configured to:
execute the instruction using the functional unit;
store the instruction with a pending commit status;
receive a programmatic state from the thread manager, wherein the programmatic state is an oldest tag among a plurality of latest tags received from the plurality of cells in the mesh system, wherein the plurality of latest tags are corresponding global tags associated with latest executed instructions by at least a portion of the plurality of cells;
determine whether the instruction is expired by comparing the global tag of the instruction against the programmatic state; and
in response to determining the global tag of the instruction is older than the programmatic state, retire the instruction.

19. The mesh system of claim 17, wherein the instruction is a first instruction and wherein the thread manager is further configured to:
receiving a subsequent instruction, wherein the subsequent instruction depends on the execution of the first instruction;
assigning, to the subsequent instruction, a second unique identification representing a corresponding allocated cell assigned to execute the subsequent instruction and a second dependency tag comprising the unique identification representing the allocated cell assigned to execute the first instruction; and
transmitting the subsequent instruction to the corresponding allocated cell for execution.

20. The mesh system of claim 19, wherein the subsequent instruction is stored in the execution queue and at least a portion of the subsequent instruction is stored in the fetch queue of the corresponding allocated cell and wherein the corresponding allocated cell is configured to request data associated with the first instruction from the allocated cell or from memory when the subsequent instruction is dequeued from the fetch queue.
